(19) United States
(12) Patent Application Publication
(10) Pub. No.: US 2008/0137377 A1
(43) Pub. Date: Jun. 12, 2008

(54) LED LIGHT ENGINE AND METHOD OF MANUFACTURING

(75) Inventors: Ronald K. Brengartner, Strongsville, OH (US); Koushik Saha, Brunswick, OH (US)

Correspondence Address: FAY SHARPE LLP, 1100 SUPERIOR AVENUE, SEVENTH FLOOR, CLEVELAND, OH, 44114, US

(73) Assignee: GELcore, LLC, Valley View, OH (US)

(21) Appl. No.: 11/609,197

(22) Filed: Dec. 11, 2006

(51) Int. Cl. G09F 9/33; H01R 33/00; H01R 13/58; H01J 9/02

(52) U.S. Cl. 362/640; 439/460; 445/23

(57) ABSTRACT

The present invention relates to a light emitting diode (LED) light engine. The LED light engine includes at least one LED, the at least one LED having at least one first electrical terminal and at least one second electrical terminal. The LED light engine further includes an electrical cable having a first conductor and a second conductor, the at least one LED being secured to the first conductor by a first insulation displacement connector (IDC) and to the second conductor by a second IDC. The first IDC includes at least one socket for receiving the at least one first electrical terminal and a piercing portion for displacing the insulating portion and electrically contacting the first conductor of the electrical cable. The second IDC includes at least one socket for receiving the second terminal of the at least one LED and a piercing portion for displacing the insulating portion and contacting the second conductor of the electrical cable.

### BACKGROUND

The present invention relates generally to the field of lighting systems. It finds particular application in conjunction with light emitting diode (LED) strips and will be described with particular reference thereto. It will be appreciated, however, that the invention is also amenable to other like applications.

LED lighting strips or light engines are known in the art for their use in various applications where decorative neon lighting systems have been or are still being used. An example of one such application is channel lettering. A more detailed discussion of LED light engines and channel lettering is provided in U.S. Pat. No. 6,660,935 to Southard et al. which is incorporated herein by reference. Generally, it is well known that LED light engines provide a quiet, safe, cost effective and reliable alternative to high voltage glass tube neon lighting.

Current methods of manufacturing an LED light engine typically involve the time consuming assembly of multiple unique components to a suitable electrical cable. In particular, the LED itself is soldered or otherwise adhered to a carrier member. The carrier member is then secured to the electrical cable. In some cases, the carrier member includes additional components to provide the necessary electrical bridge or connection between the LED and the electrical cable. This connection may be made by a connector which displaces the insulation of the electrical cable and contacts a conductor contained therein as the connector is pressed onto the electrical cable. This type of connector is commonly known as an insulation displacement connector (IDC). Further still, since at least two separate conductors are used to connect power to an anode and a cathode of the LED, additional components are used to prevent inadvertent mismatching of polarity between the LED and the power source. Because the above described assembly process is repeated for each individual LED point light source on a LED light engine, the assembly process is not only tedious but requires a voluminous quantity of each component be kept on hand. Maintaining such large inventories of components further adds to the overhead costs and financial burdens of a LED light engine manufacturer.

For these reasons, a need exists to provide a simplified yet reliable and cost effective LED light engine and LED light engine manufacturing process which eliminates extraneous components and assembly procedures.

### BRIEF SUMMARY OF THE INVENTION

In accordance with one aspect of the present invention, a light emitting diode (LED) light engine includes at least one LED, the at least one LED having at least one first electrical terminal and at least one second electrical terminal. The LED light engine further includes an electrical cable having a first conductor and a second conductor, the at least one LED being secured to the first conductor by a first insulation displacement connector (IDC) and to the second conductor by a second IDC. The first IDC includes at least one socket for receiving the at least one first electrical terminal and a piercing portion for displacing the insulating portion and electrically contacting the first conductor of the electrical cable. The second IDC includes at least one socket for receiving the second terminal of the at least one LED and a piercing portion for displacing the insulating portion and contacting the second conductor of the electrical cable.

In accordance with another aspect of the present invention, a method of manufacturing an LED light engine includes the steps of: inserting a first electrical terminal of an LED into a socket of a first insulation displacement connector (IDC), inserting a second electrical terminal of the LED into a socket of a second IDC, and inserting the first IDC into an insulated cable proximal to a first conductor of the cable. The method further includes the steps of inserting the second IDC into the cable proximal to a second conductor of the cable and molding a housing over and substantially covering the LED, the first IDC, and the second IDC.

According to yet another aspect of the present invention, a light emitting diode (LED) light engine includes an LED including a positive terminal and a negative terminal, and a first conductor and a second conductor for supplying electrical power to the LED, the first conductor being electrically insulated from the second conductor. The LED light engine further includes an electrically conductive first connector including a receptacle for receiving and securely contacting a positive terminal of the LED and a prong portion for contacting the first conductor of the electrical cable, and an electrically conductive second connector including a receptacle for receiving and securely contacting a negative terminal of the LED and a prong portion for contacting the second conductor of the electrical cable. The LED light engine also includes an overmolded housing substantially enclosing the LED, the first connector, and the second connector.

According to still another aspect of the present invention, a universal insulation displacing connector (IDC) is disclosed for electrically connecting an associated electrical device to a conductor of an associated insulated electrical cable. The universal IDC includes a conductive body, including a piercing portion adapted to pierce an insulating layer of an associated electrical cable and at least one aperture disposed in the body spaced from the piercing portion in at least two mutually perpendicular axes. The at least one aperture is adapted to receive a first terminal or a second terminal of the associated electrical device and restrict movement of the associated electrical device in at least three mutually perpendicular axes after the first terminal or the second terminal of the associated electrical device has been inserted into the aperture.

### BRIEF DESCRIPTION OF THE DRAWINGS

The invention may take form in various components and arrangements of components, and in various steps and arrangement of steps. The drawings are only for purposes of illustrating one or more embodiments of the invention and are not to be construed as limiting the invention.

FIG. 1 is perspective top view of a first embodiment of an LED light engine according to the present invention;

FIG. 2 is perspective bottom view of the LED light engine shown in FIG. 1.

FIG. 3 is a perspective view of a first side of the universal insulation displacement connector (IDC) as used and shown in the LED light engine of FIG. 1 illustrating an offset between a piercing end and a tab end.

FIG. 4 is a perspective view of a second side of the universal (IDC) of FIG. 3 illustrating a pair of lanced or partially punched sockets.

FIG. 5 is a front view of the LED light engine of FIG. 1 illustrating the engagement of a first and a second IDC with an electrical cable.

FIG. 6 is a cross-sectional edge view of the LED light engine of FIG. 5 along the first and second IDC.

FIG. 7 is a perspective view of a second embodiment of an LED light engine and IDC connector assembly, according to the present invention.

FIG. 8 is an enlarged perspective view of the first IDC connector of FIG. 7.

FIG. 9 is an enlarged perspective view of a third embodiment of an LED light engine IDC connector according to the present invention.

FIG. 10 is a perspective view of a fourth embodiment of an LED light engine and IDC connector assembly, according to the present invention.

FIG. 11 is a perspective view of the LED light engine and IDC connector assembly of FIG. 10, without an overmolded housing, illustrating an LED and an IDC subassembly.

FIG. 12 is a cross sectional view of the LED light engine and IDC connector assembly of FIG. 11.

FIG. 13 is an exploded perspective view of the LED light engine and IDC connector assembly of FIG. 10.

### DETAILED DESCRIPTION

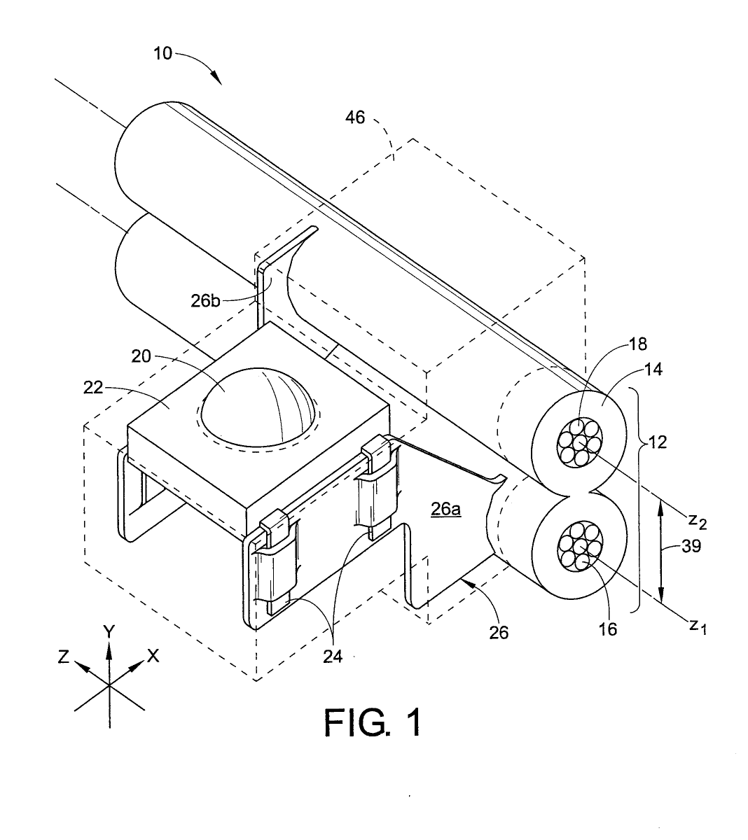

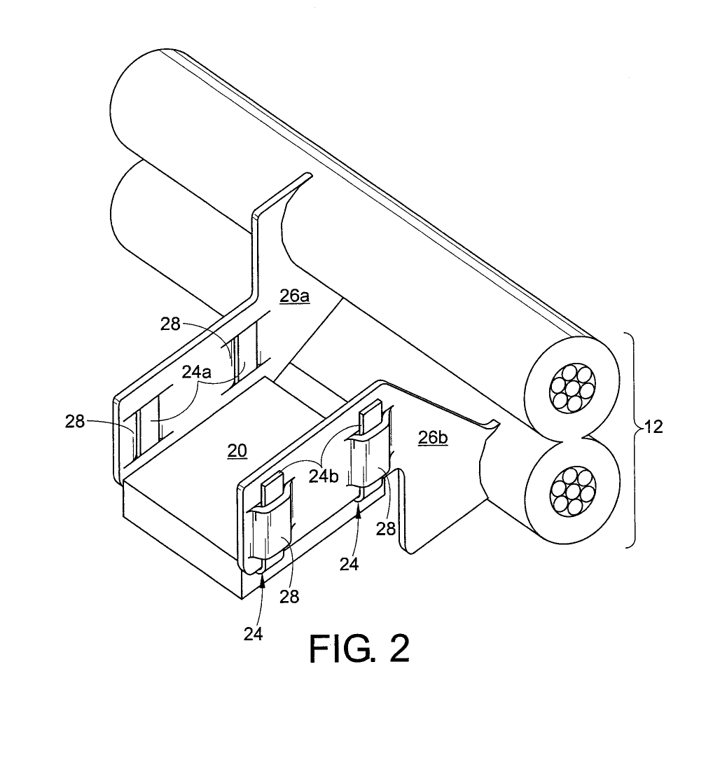

With reference to FIGS. 1-2, a light emitting diode (LED) light engine 10 includes a flexible electrical cable 12 surrounded by a flexible electrically insulating covering 14. Specifically, the cable 12 includes a plurality of substantially parallel conductors. In particular, the cable 12 includes a first conductor 16 having a longitudinal axis z₁, as well as a second conductor 18 having a longitudinal axis Z₂. Each of the conductors 16, 18 is electrically insulated by the insulating covering or portion 14. The insulating portion 14 may consist of any number of materials having non-conductive properties, such as rubber, PVC, silicone and/or EPDM. However, other materials can also be contemplated. Certain aspects of the LED light engine 10 will be described with reference to a typical three axis system. Generally, a Z axis is defined as being coincident with the longitudinal axis of the cable 12, an X axis is defined to be perpendicular to the Z axis in a horizontal plane, and the Y axis is defined as being perpendicular to both the X and Z axes.

As shown in FIGS. 1-2, the light engine 10 further includes one or more light emitting diode (LED) devices 20 which serve as the light source for the light engine 10. In particular, the LED 20 includes a body 22, as well as a plurality of electrical terminals 24. Specifically, the LED 20 includes a first pair of terminals 24a and a second pair of terminals 24b. In the first embodiment, each of the individual terminals of the first pair 24a are in electrical communication with one another and may serve as either the anode or the cathode for the LED 20. Similarly, each of the individual terminals of the second pair 24b are in electrical communication with the other and are opposite in polarity from that of the first pair of terminals 24a. Having multiple terminals of the same polarity not only ensures a reliable electrical connection but also provides additional rigidity or mechanical support for the LED 20. Of course, a fewer or greater number of terminals 24 may be used in order to provide electrical power and or mechanical support to the LED 20. In addition, depending on the particular application, some terminals may or may not be in common electrical communication with the other remaining terminals. Furthermore, different terminals may be connected to separate or auxiliary cable conductors in order to selectively operate the LED 20 to emit varying intensities or spectral hues of light.

With reference to FIGS. 1-4, the light engine 10 further includes a universal insulation displacement connector (IDC) 26. The universal IDC 26 includes a pair of sockets 28 disposed along a tab end 29 of the IDC. The sockets 28 are designed to receive the terminals 24 of the LED 20. In particular, the light engine 10 employs the use of two universal IDCs 26, a first IDC 26a and a second IDC 26b. The sockets in the tab end 29 of the first IDC 26a engage the first pair of terminals 24a of the LED 20. Similarly, the sockets in the tab end 29 of the second IDC 26b engage the second pair of terminals 24b. In addition, a piercing portion 30 is disposed opposite from the tab end. The piercing portion 30 penetrates through the insulating portion 14 of the cable 12 to engage one of the conductors in the cable. As illustrated in FIG. 6, the piercing portion 30 of the first IDC 26a, when fully inserted into the cable 12, will make a secure electrical connection with the first conductor 16. Likewise, the piercing portion of the second IDC 26b will also make a secure electrical connection with the second conductor 18.

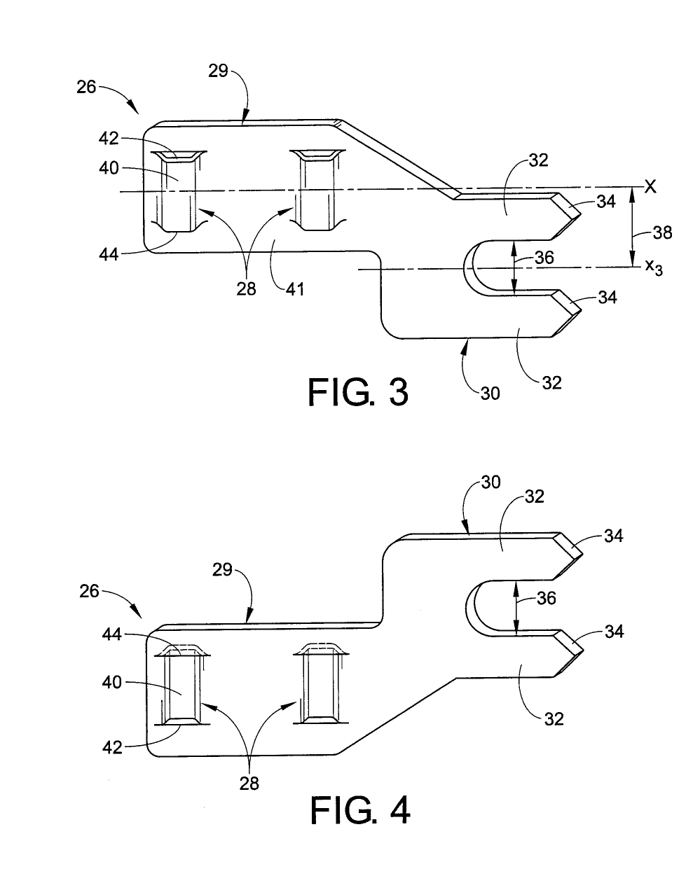

With reference to FIGS. 3-4, to effect the secure electrical connection, the piercing portion 30 of each IDC 26 includes a pair of prongs 32. Each prong 32 includes a sharpened point 34 such that the IDC may be easily inserted through the insulating portion 14, permitting the prongs 32 to capture a conductor within the electrical cable. Generally, the gap 36 between the prongs 32 is sized appropriately such that the gap is slightly smaller than a diameter of the conductor within the electrical cable. As such, when the IDC 26 is inserted into the electrical cable, the prongs 32 deflect slightly to snuggly and securely grip their respective first or second conductor 16, 18.

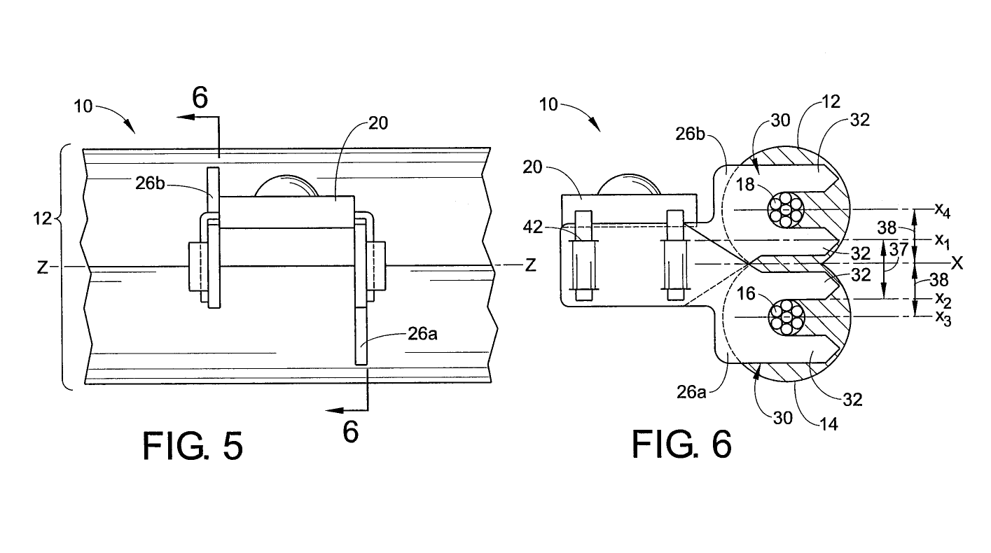

With reference to FIG. 5, the light engine 10 is shown from a front view illustrating the spacing between the first IDC 26a and the second IDC 26b along the Z axis. Of course, the first and second IDC 26a, 26b may be fabricated from any conductive material such as solid sheet metal. By way of example, the IDCs may be rapidly stamped or punched from a flat sheet of copper, aluminum, or other conductive material via a high speed stamping or punching machine. On the other hand, a non-conductive substrate having a conductive plating or coating could be used. In addition, to keep manufacturing costs at a minimum, the IDCs may be installed in a spaced apart manner, as shown in FIG. 5, in order to avoid the use of a separate insulator between the first IDC 26a and the second IDC 26b.

With reference once again to FIGS. 3-4, the sockets 28 of the universal IDC 26 may be formed in any number of ways. One cost effective method of producing the sockets 28 within the universal IDC 26 would be to partially punch or lance the end portion of the universal IDC 26. The universal IDC 26 would be partially punched or lanced such that a partially punched portion 40 becomes elevated as shown in FIG. 3 (or recessed as shown in FIG. 4) with respect to a contact surface 41 of the IDC 26. During this partial punching or lancing process, a first slit 42 and a second slit 44 are produced about the partially punched portion. The two slits in combination with the partially punched portion 40 form the socket 28. Whether the first slit 42 or the second slit 44 is the entrance or the exit of the socket is dependant upon the orientation of the IDC 26 (see FIG. 1, for example). It should be noted that when a terminal of the LED is inserted into the socket 28 it is held securely and restricted from moving in either of the X or Z axes. The LED 20 is also limited from downward movement in the Y axis. By way of example, one of the terminals of the LED enter initially through the first slit 42, then past the partially punched portion 40, and lastly through the second slit 44. The amount or depth to which the partially punched portion 40 is displaced is dependent on the overall thickness and width of the terminal to be used. Typically, a slight interference between the contact surface 41 and the punched portion 40 is preferred, such that once the terminals of the LED are inserted into the IDCs, the LED will be held securely. An appropriate interference fit will help prevent loosening or separation (mechanical and electrical) between the LED and the IDC due to handling, vibration, or other environmental factors.

With reference to FIGS. 1-4, it should also be noted that the IDC 26 is universal in that it may be attached to either set of terminals 24a, 24b of the LED 20. In other words, the universal IDC 26 may be used to secure the first pair of terminals 24a of the LED 20 to the first conductor 16 or, by simply rotating the universal IDC 26 1800 about the X axis, the IDC may be used to connect and secure the second pair of terminals 24b of the LED 20 to the second conductor 18. This universal use or interchangeability of the IDC can be attributed to a first offset 37 (FIG. 6) that is present between a first minor X axis x₁ along an the entrance of the socket 28 or slit 42 (FIG. 6), and a second minor X axis x₂ (FIG. 6) which is the nearest portion of the first IDC 26a that contacts an upper portion of the first conductor 16 as measured in the Y axis. In addition, FIGS. 3 and 6 illustrate a second offset 38 between the major X axis X (which generally bisects the sockets 28) and a third minor X axis X₃ or a fourth minor X axis X4 (which is generally a transverse centerline of the first and second conductors 16,18, respectively). The second offset 38 can also be defined as being half a distance 39 between the longitudinal axis z₁ (FIG. 1) of the first conductor 16 and the longitudinal axis Z₂ (FIG. 1) of the second conductor 18. For these same reasons, the first and second IDCs 26a, 26b are also geometrically symmetrical.

Naturally, the universal IDC functions more reliably if the spacing between the conductors remains relatively constant and if the conductors are separated by an adequate amount of insulating material. An adequate amount of insulating material helps to prevent the prongs of the IDC from disturbing, shorting, or arcing against an adjacent conductor when the IDC is inserted into the cable. As shown with reference to FIG. 6, the LED 20 is attached to the cable 12. A cross section along the first and second IDC 26a, 26b are also shown. As discussed previously, in order to minimize potential shorting, the prongs 32 of the piercing portions 30 are sized such that they are wholly contained within the insulating portion 14 of the cable 12.

With reference to FIGS. 1-6, the method of making the LED light engine 10 begins initially by slidably engaging the first set of terminals 24a of the LED 20 representing the anode or cathode into the sockets 28 of the first IDC 26a. This process is then repeated or occurs simultaneously with slidably engaging the second set of terminals 24b of the LED 20 (representing the opposite polarity of the first terminals 24a) into the sockets 28 of the second IDC 26b. Next, the cable 12 is held securely while the LED and IDC assembly are pressed into the cable 12. As the piercing portions 30 of the IDCs 26 penetrate the insulating material 14 of the cable 12, each prong 32 of the IDCs eventually encounters the respective first and second conductors 16, 18 in the cable 12. The prongs 32 deflect outwardly and a contact pressure is generated between the conductor and the IDC due to the elastic strain. Optionally, the entire LED and IDC assembly may be over-molded using injection and molding techniques to provide a protective housing 46. The protective housing 46 further restrains movement between the LED 20, the first and second IDCs 26a, 26b and the immediate area or portion of the cable 12 surrounding the insertion points of the IDCs 26a, 26b. The housing may be of a clear, opaque, flexible or rigid plastic, rubber, polymer, silicone, EPDM or any other material having electrically non-conductive properties. As such, an efficient method of manufacturing an LED light engine is disclosed which involves the use of fewer components than other prior art LED light engines without sacrificing quality or reliability.

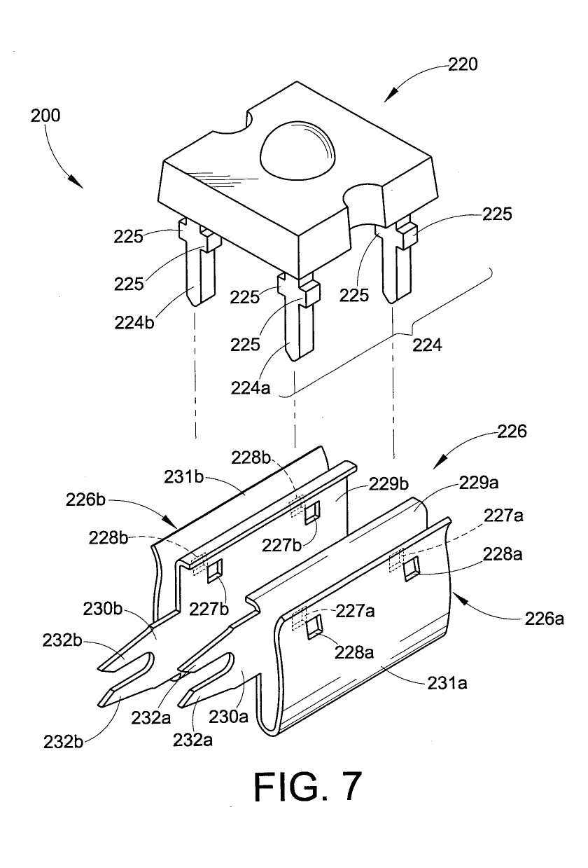

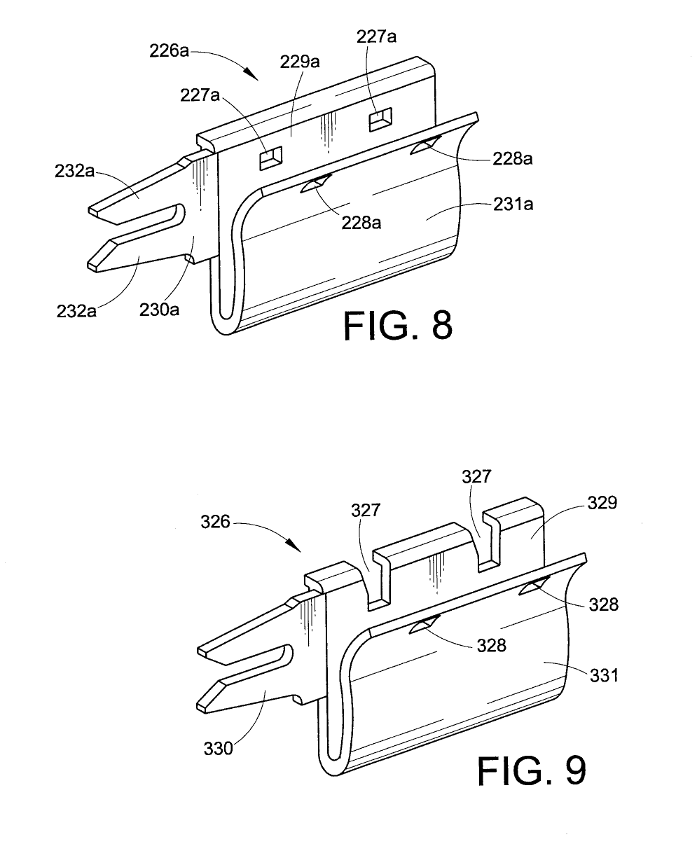

Now with reference to FIGS. 7-8, a second embodiment of a portion of an LED light engine assembly 200 is shown. As with the first embodiment, the LED light engine assembly 200 includes an LED 220 having a plurality of terminals 224 which are divided into a pair of first terminals 224a having one polarity and a second pair of terminals 224b having an opposite polarity. The terminals include a generally elongated rectangular parallelepiped portion having a pyramid shaped end that is inserted into a socket of the IDC. Each of the terminals 224 include a pair of locking tabs 225 for securely engaging a pair of insulation displacement connectors (IDC) 226. The tabs 225 give the terminals 224 a cross-shaped configuration. As in the first embodiment, the first set of terminals 224a are slidably engaged into a first IDC 226a, whereas the second set of terminals 224b are slidably engaged in a second IDC 226b. Specifically, the locking tabs 225, which extend outwardly from the outer surface of the rectangular parallelepiped portion of the first and second terminals 224a, 224b respectively, engage a pair of inner apertures 227a, 227b and a pair of outer apertures 228a, 228b.

The inner apertures 227a, 227b are located along a body portion 229a, 229b of the respective first and second IDCs 226a, 226b. Extending forwardly from the body portions 229a, 229b are a pair of piercing portions 230a, 230b which are intended to engage a set of conductors found within a cable, such as cable 10 shown in FIG. 1. The piercing portions 230a, 230b further include a pair of prongs 232a, 232b for piercing the insulation of the cable and trapping the respective conductor therebetween.

The first and second IDCs 226a, 226b further include a clip portion 231a, 231b. The clip portions 231a, 231b serve primarily two functions. First, the clip portions 231a, 231b serve as an additional conductive member to ensure greater electrical conductivity between the conductors of the cable and the terminals of the LED 220. Second, the clip portions 231a, 231b are a resilient or biasing member that applies inward clamping pressure towards the respective body portions 229a, 229b in order to securely retain the terminals 224 within the IDCs 226a, 226b. The upper portion of each IDC can have a wider opening at the top that tapers inwardly moving downward towards the bottom. Moreover, the clip portion can be somewhat S-shaped to encourage a resilient snap fit of the terminal into the IDC. Furthermore, the clip portions 231a, 231b in combination with the inner and outer apertures 227a, 227b, 228a, 228b restrain the terminals 224 and the LED 220 from translating or rotating in three orthogonal axial directions.

Now with reference to FIG. 9, a third embodiment an IDC connector, which can be used in a light engine, is shown. In most respects, the third embodiment of an IDC connector 326 is the same as the IDC connector 226a of the second embodiment. As with the second embodiment, the third embodiment includes a pair of inner and outer engaging portions 327, 328, a body portion 329, a piercing portion 330, and a clip or biasing portion 331. However, one distinction involves the inner engaging portion 327 which is a slot. One potential advantage to using a slot and aperture combination, as shown in FIG. 9, is that it provides the same triaxial method of securing the LED within the IDC, yet permits greater ease of manufacturability. During the manufacturing process, the LED self aligns with respect to the IDC as the LED is pressed into the clip portion of the IDC. In other words, as the tab portions on the terminals of the LED are slid into the IDC 326, the inner tabs will encounter the slots 327 thereby guiding the terminals and properly aligning them such that the outer tabs of the terminals of the LED can easily locate the outer apertures 328. To enhance this self-aligning feature of the slots 327, the slots may be slightly V-shaped or tapered, such that the width of the slot is greater at the entry point than it is at the base portion of the slot 327.

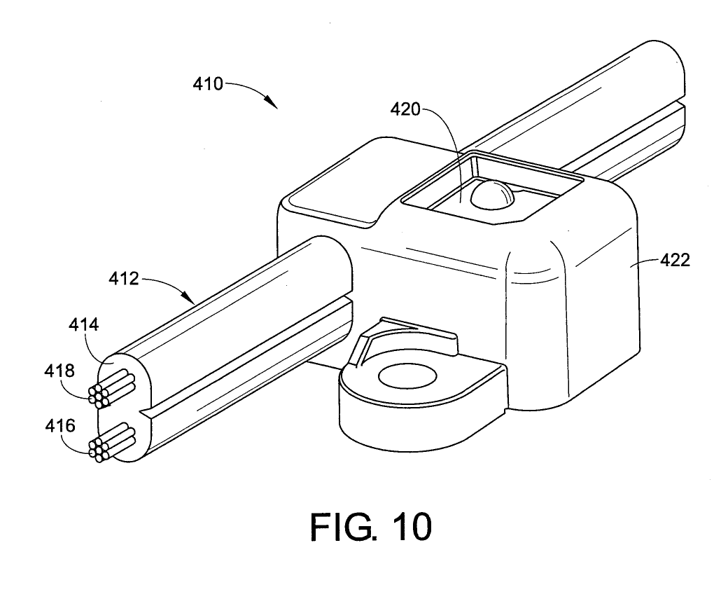

With reference to FIG. 10, a fourth embodiment of an LED light engine 410 is shown. The light engine 410 includes a cable having an insulating portion 414 and a first and second conductor 416, 418. As with the first embodiment of the light engine 10, an LED 420 is electrically connected to the conductors of the cable 412 to provide a light source when energized. Furthermore, the light engine 410 includes an overmolded housing 422 which provides a substantially air tight outer structure. The overmolded housing 422 includes an opening through which a lens of the LED 420 extends. Of course, the overmolded housing 422 could entirely encapsulate the LED 420 if the housing 422 were made of a clear or light-transmitting material. As will be discussed below, the housing 422 maintains the internal components of the LED light engine in proper alignment and helps to retain solid electrical contact between the LED 420 and the cable 412.

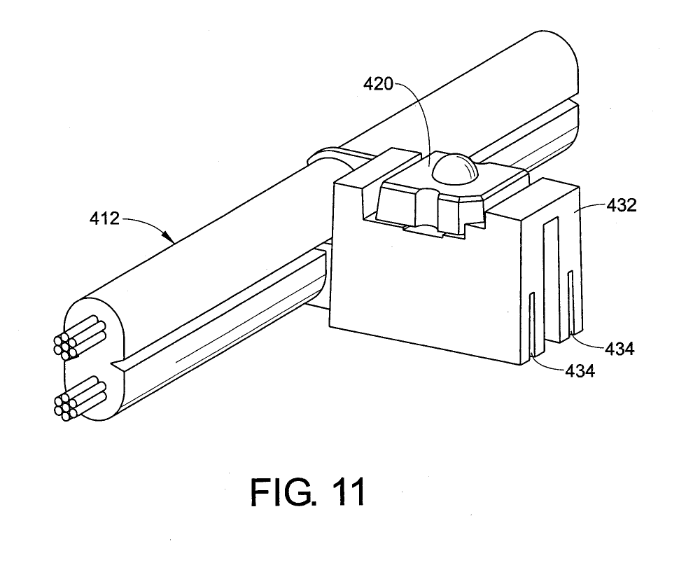

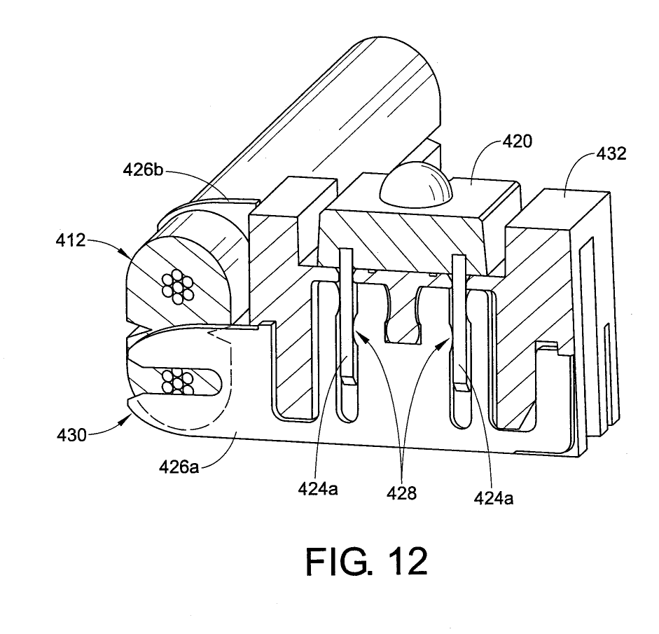

With reference to FIGS. 11 and 12, the LED light engine is shown without the overmolded housing and thus exposing the internal components of the LED light engine. In particular, a first set of electrical terminals 424A of the LED 420 are shown engaged with a first IDC 426A. In addition, a second set of LED terminals 424B (not shown) are engaged in a second IDC 426B. The first and second IDCs 426A, 426B respectively engage the first and second conductors of the cable 412. The LED terminals 424A, 424B are received into the respective sockets 428 of the IDCs. Also, a piercing or prong portion 430 of each IDC 426A, 426B is securely engaged with its respective conductor in the cable 412. Furthermore, the first and second IDC 426A, 426B are slidably received or pressed into a header 432 which maintains the proper vertical alignment of the IDCs during assembly and operation.

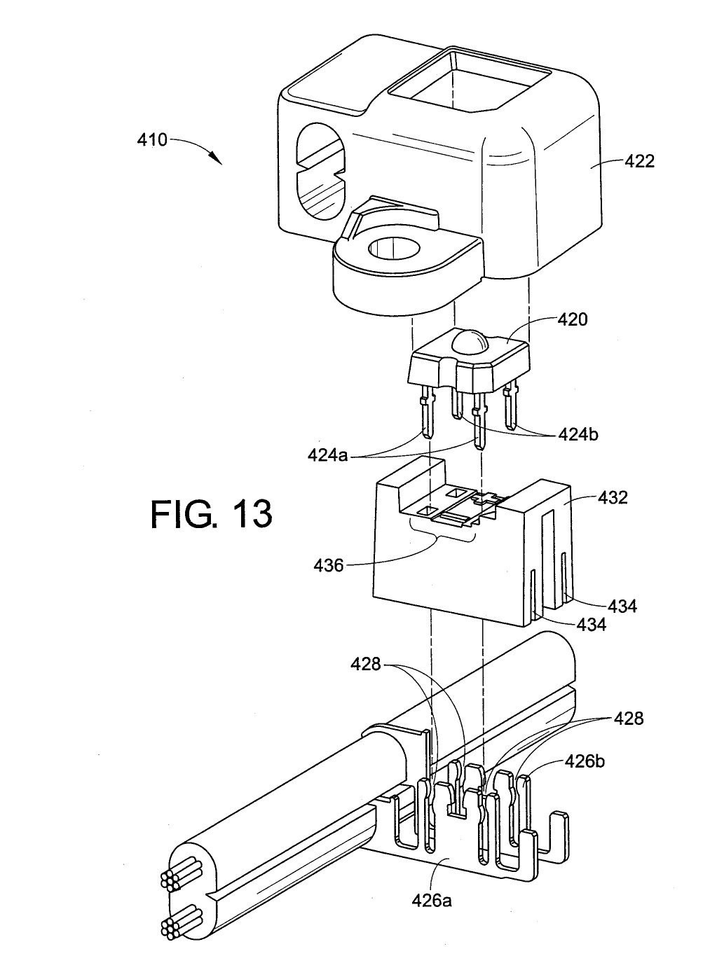

With reference to FIG. 13, an exploded view of the LED light engine 410 is shown. Generally, the first and second IDC 426A, 426B are slidably received into an IDC slot 434 from a bottom surface of the header 432. A slight interference or press fit may be used to secure the IDCs 426A, 426B in the header 432. The header 432 also includes a plurality of apertures 436 which are intended to receive the first and second terminals 424A, 424B of the LED 420. Once the LED 420 is pressed into the header 432 and received into the sockets 428 of the IDCs 426A, 426B, the housing 422 is then molded over the LED 420, the IDCs 426A, 426B, the header 432, and the cable 412 (FIG. 10) creating an air tight assembly. The molding process is generally performed by taking the pre-overmolded LED light engine assembly and placing it within an injection molding machine. A thermoplastic or thermoset plastic is then injected into the mold that surrounds the pre-overmolded asssembly. Naturally, depending on the operating environment and handling requirements of the LED light engine, the plastic may be selected to have the appropriate elasticity or modulus as well various electrical and or thermal properties. Alternatively, the housing could be extruded by running the cable and pre-overmolded assembly through the die of a plastic extruding machine.

It should be noted that once overmolded, the internal components of the LED light engine are locked into place. In particular, the sockets 428 of the IDCs 426A, 426B cooperate with the header 432 and the overmolded housing 422 to secure the LED 420 in three mutually independent axes.

In addition, the overmolded housing 422 serves as a heat dissipating member. Because the housing 422 surrounds and is in contact with the body of the LED 420, heat transfer occurs by conduction (which is more efficient than heat transfer by convection) from the body of the LED to the housing 422. Since the housing is forcibly injected or molded under high pressure there are few if any air pockets between the body of the LED 420 and the overmolded housing 422. This effectively transforms the overmolded housing 422 into an extension of the body of the LED which acts as a heat sink to lower the temperature of the LED during operation. Thus, the LED 420 may be driven at higher current levels thereby producing a higher light intensity. Similarly, the longevity of the LED is increased due to the additional heat dissipation and lower operating temperatures.

It should be noted that the present invention may be used in various types of LED light engines. One application of such a cost effective LED light engine design would be in channel lettering. Channel lettering was customarily manufactured using high voltage neon lighting. Advancements in the art of LEDs and LED light engines now provide a cost effective, and energy efficient alternative to neon lighting. The IDC of the present invention further simplifies the manufacturing of state of the art LED light engines making them more reliable and cost effective. It should also be noted that the IDC can be used to connect other electrical devices, e.g. PCBs, incandescent lights, etc., to an insulated electrical cable. In addition, the IDC of the present invention can take many other configurations other than those particularly described. For example, the tab end may reside in a plane that is perpendicular to the end of the IDC that is inserted into the electrical cable.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1-5. (canceled)

6. The LED light engine of claim 16, wherein the LED device includes a plurality of electrical terminals, one or more of the plurality of electrical terminals being insulated from the other, for selectively varying an intensity or hue of the at least one LED, the plurality of electrical terminals being in electrical communication with the conductors.

7. The LED light engine of claim 16, wherein the LED light engine is formed into an alphabetic shape.

8. The LED light engine of claim 16, wherein a channel letter housing is disposed about the LED light engine.

9. The LED light engine of claim 16, wherein the overmolded housing substantially encloses the LED device, the first connector, the second connector, and at least a portion of each of the first conductor and the second conductor.

10. A method of manufacturing an LED light engine, the method comprising:
inserting a first electrical terminal of an LED into a socket of a first insulation displacement connector (IDC);
inserting a second electrical terminal of the LED into a socket of a second IDC;
inserting the first IDC into an insulated cable proximal to a first conductor of the cable;
inserting the second IDC into the cable proximal to a second conductor of the cable; and
molding a housing over and substantially covering the LED, the first IDC, and the second IDC.

11. The method of claim 10, further comprising the step of orienting the second IDC approximately one hundred and eighty (180) degrees opposite to the orientation of the first IDC prior to inserting the second IDC into the cable, and wherein the first IDC and the second IDC are geometrically identical.

12. The method of claim 10, wherein the step of inserting the first IDC and the step of inserting the second IDC occur simultaneously.

13. The method of claim 10, further comprising the step of inserting the first IDC and the second IDC into a header prior to inserting the terminals of the LED into the respective sockets of the first IDC and the second IDC.

14. The method of claim 10, wherein the molding step further includes molding the housing over a portion of the insulated cable.

15. The method of claim 10, wherein the molding step further comprises injection molding a thermoplastic, liquid injection molding a material, casting a material or extruding a material to form the housing integrally with the LED and the first and second IDCs.

16. A light emitting diode (LED) light engine, comprising:
an LED device including a positive terminal and a negative terminal, each depending from the LED;
a first conductor and a second conductor for supplying electrical power to the LED, the first conductor being electrically isolated from the second conductor;
an electrically conductive first connector including a receptacle that receives the positive terminal of the LED and a prong portion that contacts the first conductor of the electrical cable;
an electrically conductive second connector including a receptacle that receives the negative terminal of the LED and a prong portion that contacts the second conductor of the electrical cable; and
an overmolded housing partially encapsulating the LED and at least one of the first connector or the second connector.

17. The LED light engine of claim 16, wherein the receptacle of the first connector and the receptacle of the second connector mechanically receives the respective positive and negative terminals of the LED to restrain the positive and negative terminals in three mutually perpendicular axes.

18. The LED light engine of claim 16, further comprising a header including a first slot and second slot, the first connector and the second connector being slidably engaged with the header.

19. The LED light engine of claim 16, wherein the overmolded housing substantially encloses the LED, the first connector, and the second connector.

20. The LED light engine of claim 16, wherein the overmolded housing comprises a material having a thermal conductivity greater than air.

21. (canceled)

22. The LED light engine of claim 16, wherein each electrically conductive connector is generally flat.

23. The LED light engine of claim 16, wherein each electrically conductive connector includes two or more receptacles.

24. The LED light engine of claim 16, wherein each receptacle is defined by a raised portion offset from a contact plane, the respective terminals being secured between the raised portion and the contact plane.

25. A light emitting diode (LED) light engine, comprising:
an LED including a first terminal and a second terminal, the first terminal and the second terminal each including at least one outwardly protruding tab;
a first conductor and a second conductor for supplying electrical power to the LED, the first conductor being electrically insulated from the second conductor;
a first insulation displacing connector (IDC) including a clip portion for receiving the first terminal of the LED, a prong portion for contacting the first conductor of the electrical cable, and a tab engaging portion for engaging the at least one tab of the first terminal;
a second insulation displacing connector (IDC) including a clip portion for receiving the second terminal of the LED, a prong portion for contacting the second conductor of the electrical cable, and a tab engaging portion for engaging the at least one tab of the second terminal;and
wherein the clip portions and the tab engaging portions of the first and second IDCs cooperate to confine movement of the LED in three mutually perpendicular axes when the first and second terminals of the LED are received into the respective first and second IDC.

26. The LED light engine of claim 25, wherein the tab engaging portion is an aperture.

27. The LED light engine of claim 25, wherein the tab engaging portion is a slot.

28. The LED light engine of claim 26, wherein the slot is tapered.

29. (canceled)

30. The LED light engine of claim 25, further comprising an overmolded housing substantially enclosing the LED, the first connector, and the second connector.
